(19) United States
(12) Patent Application Publication
(10) Pub. No.: US 2004/0140669 A1
(43) Pub. Date: Jul. 22, 2004

(54) Thread for pipe joint

(76) Inventors: William Alan Powers, Lovington, NM (US); Arvel M. Berry, Lovington, NM (US)

Correspondence Address: Ross T. Robinson, Esq., Jenkens & Gilchrist, A Professional Corporation, 1445 Ross Avenue, Suite 3200, Dallas, TX, 75202-2799, US

(21) Appl. No.: 10/696,050

(22) Filed: Oct. 29, 2003

Related U.S. Application Data
(60) Provisional application No. 60/422,627, filed on Oct. 30, 2002.

(51) Int. Cl. F16L 25/00

(52) U.S. Cl. 285/334; 285/390

(57) ABSTRACT

A pipe connection includes a threaded pin and a threaded box for securely forming a metal-to-metal seal. The pin includes an elongated thread section forming threads that are oriented with angled front and rear faces. The pin also includes a sealing surface for direct engagement with an interior surface of the box, preventing the exacerbation of corrosion of the threads.

### CROSS-REFERENCE TO RELATED APPLICATIONS

This patent application claims priority from, and incorporates by reference the entire disclosure of, U.S. Provisional Patent Application No. 60/422,627, which was filed on Oct. 30, 2002.

### BACKGROUND OF THE INVENTION

1. Technical Field of the Invention

The present invention relates to threaded pipe joints, including male and female sections, and more particularly, but not by way of limitation, to a structurally enhanced thread profile particularly adapted for oil and gas tubing and casing liners.

2. Description of Related Art

It is common practice in the drilling industry to utilize pipe joints to join pipes of the type comprising a male section and a female section with corresponding threadings. The male and female sections are usually located directly at the ends of the pipes or in coupling sleeves or nipples. Various thread arrays have been utilized in prior years and various thread-sealing combinations, such as metal-to-metal seals and metal-to-thermoplastic ring seals, have also been proposed.

Operationally, current industry trends include multiple completions from a single well bore, as well as re-entry and side tracking of old well bores. These trends have led to various developments such as semi-flush connections and flush joint connections. Semi-flush connections with expanded boxes meet the needs of higher compression capability (pushing casing through the turns), higher tensile strength (pulling to break hydraulic sticking), and tighter turning radius (reducing the length of the curve) The flush joint connections with dove tail threads are also capable of managing higher compression loads and higher tensile loads while exhibiting a tighter turning radius.

Various U.S. patents teach thread profiles particularly adapted for such pipe applications. For example, U.S. Pat. No. 4,494,777 teaches a threaded pipe joint including male and female sections, each with corresponding closed angle threading. The closed angle threading diminishes in height in the region adjacent the abutments, which limit axial movement of the sections with respect to each other and thereby prevent movement which would permit the closed angled threads to separate.

Other patents exemplary of pipe joint designs include U.S. Pat. No. 4,591,195 which teaches an improvement to the sealing ring to a sealing ring set forth in U.S. Pat. No. 4,085,951. Similarly, U.S. Pat. No. 4,564,225 teaches multiple lead threading for joining together sections of casing or tubing. The exterior ends of adjacent casing or tubing sections and the opposite interior ends of a coupling device are matingly threaded, the threading thereof having plural leads.

U.S. Pat. No. 4,707,001, the entire disclosure of which is herein incorporated by reference for any purpose, teaches a connection for plane end well liner pipe and the like using a threaded pin and box having an advantageous locking reverse angle thread profile to prevent radial separation of the pin and box due to deep well pressure and makeup pressures. The pipe joint includes a primary internal seal structure wherein a metal-to-metal inference seal is located adjacent a thermoplastic ring seal. A seal-ring groove is formed in the box portion and within the groove is the thermoplastic ring, typically made of a fiberglass-filled virgin TEFLON material or the like. A thread of the pin portion compresses the thermoplastic seal to increase the bearing pressure of the connection. It has been noted that the thermoplastic ring can degenerate over time and eventually disintegrate to such an extent that fluid flowing inside the connection pools in the region of the degenerated seal exacerbating corrosion. More particularly, because continuous metal-to-metal engagement is not made, pockets such as the seal ring groove and threads of the male portion in the area of the seal ring groove create a void where fluid may collect and the above-referenced exacerbation of conventional corrosion of the surrounding metal piping may occur. Moreover, it has been recognized that increased strength of the connection may have significant import when deleterious exacerbated corrosion can be eliminated over long periods of use.

Therefore, there is a need for a pipe connection with an advantageous locking reverse angle thread profile and enhanced structural aspects that also create an adequate seal to prevent fluid from further exacerbating conventional corrosion of the pipe connection under increasingly higher stresses such as compression loads and tensile loads.

### SUMMARY OF THE INVENTION

The present invention relates to a pin and box pipe connection with reverse locking threads. In one aspect, the pipe connection comprises a pin formed with an elongated thread section and a sealing surface. The elongated thread section includes reverse locking pin threads along the entire length of the thread section. The pipe connection also includes a box formed with box threads along an interior surface for direct engagement with pin threads of the thread section. The sealing surface forms a metal-to-metal seal with the box and the pin threads engage with the box threads along the entire length of the thread section, preventing the pooling of fluids to exacerbate corrosion.

In another aspect, a pin adapted for use in a pipe connection includes an elongated thread section forming reverse locking threads along the entire length of the thread section, a sealing surface adapted for forming a metal-to-metal seal with an interior surface of a box, and a pipe portion adapted for allowing fluid flow therethrough. The thread section forms a metal-to-metal seal with the interior surface of the box along the entire length of the thread section, preventing the pooling of fluids to exacerbate corrosion.

In another aspect, a box adapted for use in a pipe connection includes an interior surface for mating with a sealing surface of a pin, an elongated thread section forming reverse locking threads along the entire length of the thread section, and an end section for mating with a dovetail arrangement of the pin. The interior surface forms a metal-to-metal seal with the sealing surface and the thread section engages with the pin along the entire length of the thread section, preventing the pooling of fluids to exacerbate corrosion.

In another aspect, the present invention relates to a pin and box connection for tubular members. The tubular members are of the type having a multi-groove helical thread with each groove having an entrant portion equidistant with adjacent groove entrant portions and with each groove including a negative draft load flank. The helical threads extend the entire length and include an end helical thread which abuttingly engages a box portion for creating a metal-to-metal seal along the entire length of the multi-groove helical thread and the end helical thread, preventing the pooling of fluids to exacerbate corrosion.

### BRIEF DESCRIPTION OF THE DRAWINGS

A more complete understanding of principles of the present invention may be obtained by reference to the following Detailed Description when taken in conjunction with the accompanying Drawings wherein:

FIG. 1 is a side elevational view of a male portion of the pipe joint configuration of an embodiment of the present invention;

FIG. 2A is a side elevational view of the thread configuration of an embodiment of the present invention;

FIG. 2B is a side elevational view of the thread configuration and shoulder of an embodiment of the present invention;

FIG. 3 is a perspective view of a pipe joint configuration in accordance with an embodiment of the present invention;

FIG. 4 is a side elevational view of the thread configuration of the pin and box of an embodiment of the present invention;

FIG. 5A is a plot diagram of end load versus elapsed time for an embodiment of the present invention; and

FIG. 5B is a plot diagram of tensile load versus displacement for an embodiment of the present invention.

### DETAILED DESCRIPTION OF EXEMPLARY EMBODIMENTS OF THE INVENTION

By utilizing a using a closed-angled thread, such as a locking reverse angled thread profile in a flush joint connection utilizing twin leads and hook threads, the need for a seal ring groove can be eliminated and an extra thread can be incorporated in the joint. Eliminating the seal groove and adding an extra thread increases the critical area of the connection. By doing this, embodiments of the present invention maintain integrity under increased compression loads and increased tensile strength loads. A tighter turning radius may also be achieved by an embodiment of the present invention.

Referring now to the drawings, FIG. 1 illustrates a male section 100 of a pipe connection. The male section, or pin 100, includes a pipe portion 102 and a thread portion 104 for connecting with a corresponding female section, hereinafter referred to as a box (not shown). The thread portion 104 includes threads 106 on an external face of the pin 102 that cooperate with threads on an internal face of the box. The threads 106 may be equidistant from each other or the distance between threads 106 may vary depending on the application. In addition, the thread height may be constant or vary for particular applications. Although the illustration utilizes 12 threads, it will be understood that the number of threads may vary depending on the particular application and the diameter of the pipe connection without departing from principles of the invention. By utilizing an elongated thread portion 104, the critical area of the connection is extended. Increasing the critical area provides for a pipe connection capable of withstanding higher stresses that are experienced in the drilling or oil and gas industries. The threads 106 maintain engagement with the box along the length of the thread portion 104.

The pin 100 also includes a sealing surface 114 to forming a metal-to-metal seal with the box. By maintaining contact between the sealing surface 114, the threads 106, and the box, the connection formed between the pin 100 and box is stronger than a connection that does not maintain contact throughout the sealing surface 114 and thread portion 104. For instance, if a groove or void was formed in either the thread section 104 of the pin 100, or along an inner surface of the box, the critical area of the connection is decreased and therefore weaker. Fluid may also collect in the groove or void and lead to corrosion of the pipes.

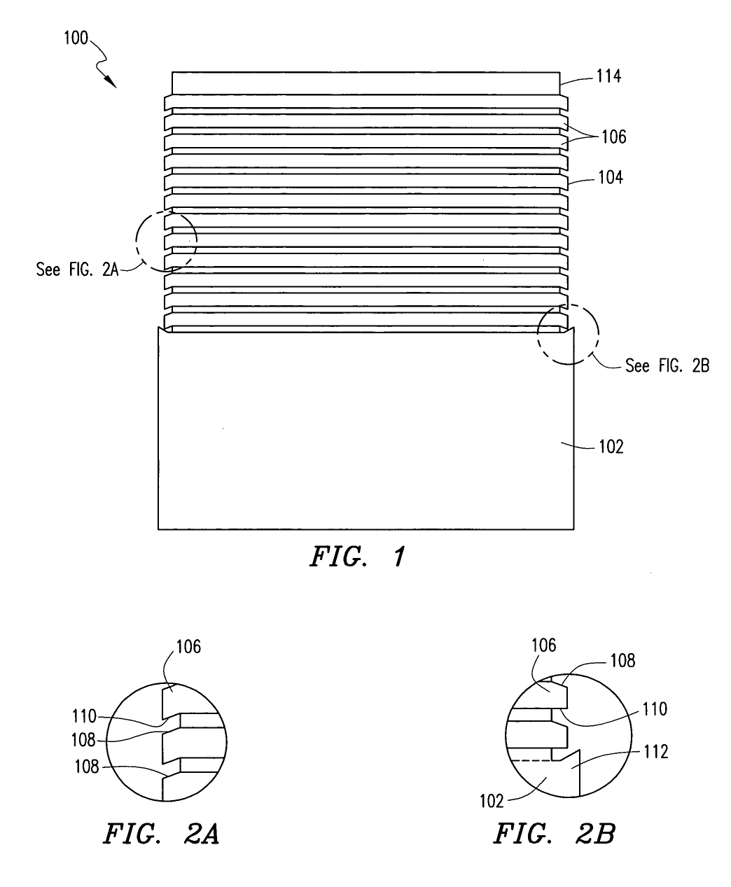

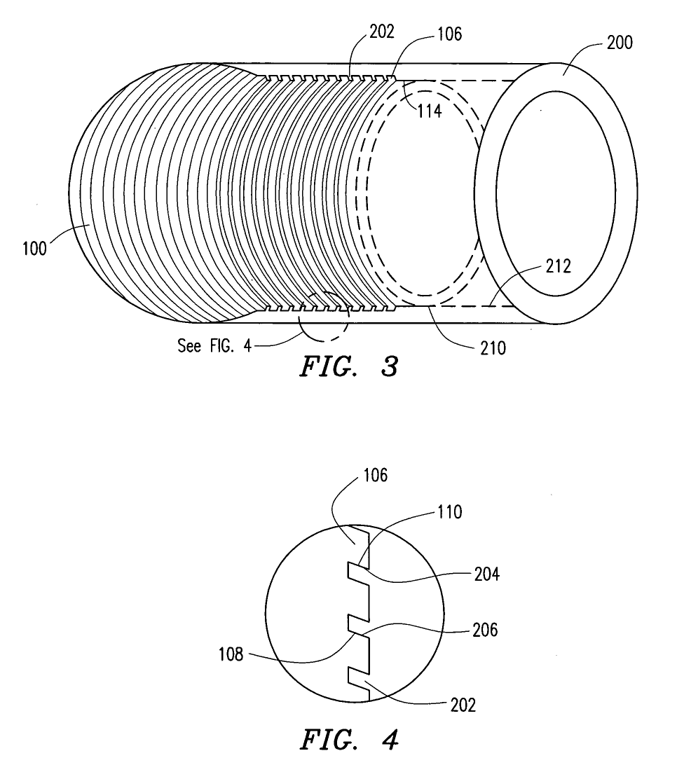

Now referring to FIGS. 2A and 2B, the threads 106 are shown in more detail. A front face 108 of the thread 106 is angled at preferably a 45° angle for engagement with the box. A rear face 110 of the thread 106 is also angled to provide locking securement to the pin by preventing radial separation of the threads 106. The rearmost thread 106 and a protrusion 112 of the pipe section 102 form a modified dove-tail arrangement for securing the rearmost end of the box. The dove-tail arrangement provides additional integrity and locking securement between the pin 100 and box of the pipe connection.

Now referring to FIG. 3, a perspective view of the pipe connection including the pin 100 and box 200 of the present invention is illustrated. As previously described, the threads 106 of the pin 100 interlock with threads 202 of the box 200. The sealing surface 114 of the pin 100 forms a metal-to-metal seal 210 with an interior surface 212 of the box 200. The metal-to-metal seal 210 prevents fluid from flowing between the threads 106, 202 of the pin 100 and box 200.

As shown in greater detail in FIG. 4, the threads 106 of the pin 100 are in direct engagement with the threads 202 of the box 200. The orientation of the threads 202 of the box form a direct mating relationship with the threads 106 of the pin 100. A front face 204 of the threads 202 of the box 200 is oriented at an angle corresponding to the angle chosen for the back face 110 of the threads 106 of the pin 100. Similarly, a back face 206 of the threads 202 of the box 200 is oriented at an angle corresponding to the angle of the front face 108 of the threads 106 of the pin 100. The threads 106, 202 maintain contact between the pin 100 and box 200 in order to minimize areas where fluid may migrate, thereby reducing the possibility of corrosion of the pipe connection. As illustrated herein, no voids exist that allow fluid to collect or pool so that corrosion may advance at a higher rate. Also by extending the thread portion 104 of the pin 100 and the thread portion of the box 200, a more secure connection is maintained between the pin 100 and box 200 as illustrated in greater detail below.

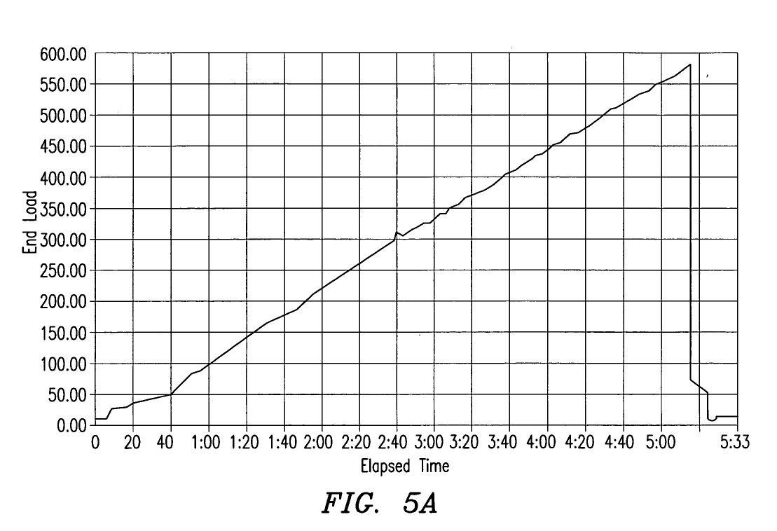

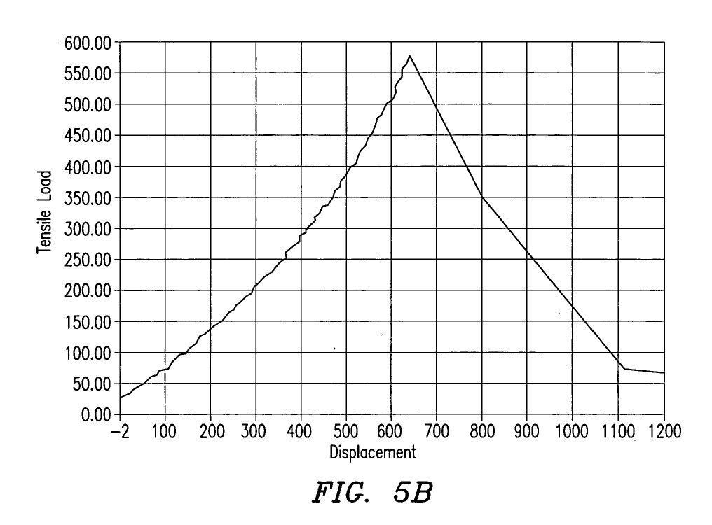

Referring now to FIGS. 5A and 5B, plot diagrams illustrating the capability of an embodiment of the present invention to withstand stresses are shown. As shown in FIG. 5A, a plot of an end load on a 5½ outer diameter pipe utilizing the pipe connection of an embodiment of the present invention is shown. The x-axis illustrates the elapsed time in hours and the y-axis illustrates the amount of end load in thousands of pounds. The pipe connection maintains integrity for over five hours and fails at about 580,000 pounds of end load on the connection. FIG. 5B illustrates a tensile loading plot for a similar 5½ outer diameter pipe utilizing the pipe connection of an embodiment of the present invention. Tensile loading causes the pipe material and the pipe connection to stretch lengthwise. Therefore, the x-axis represents the linear displacement when the pipe connection stretches during tensile loading. The y-axis represents the tensile load in thousands of pounds. The tensile load is increased to 580,000 pounds, which cause the connection to stretch about 640 mils.

The previous description is of a preferred embodiment for implementing principles of the invention, and the scope of the invention should not be limited by this description. The scope of the present invention is instead defined by the following claims.

What is claimed is:

1. A pipe connection comprising:
a pin formed with an elongated thread section and a sealing surface, the elongated thread section including reverse locking pin threads along the entire length of the thread section;
a box formed with box threads along an interior surface for direct engagement with pin threads of the thread section; and
wherein the sealing surface forms a metal-to-metal seal with the box and the pin threads engage with the box threads along the entire length of the thread section for preventing the exacerbation of corrosion of the box threads.

2. The pipe connection of claim 1, wherein the pin threads comprise:
a pin thread front face oriented at a first predetermined angle; and
a pin thread rear face oriented at a second predetermined angle.

3. The pipe connection of claim 2, wherein the box threads comprise:
a box thread front face oriented at a substantially similar angle as the pin thread rear face; and
a box thread rear face oriented at a substantially similar angle as the pin thread front face.

4. The pipe connection of claim 1, wherein the interior surface of the box and the sealing surface of the pin maintain continuous contact.

5. The pipe connection of claim 2, wherein the first predetermined angle is 45°.

6. The pipe connection of claim 2, wherein the first predetermined angle and the second predetermined angle are different.

7. The pipe connection of claim 1, further comprising a dovetail arrangement for securing an end section of the box.

8. The pipe connection of claim 1, wherein the pin threads are spaced equidistant from each other.

9. The pipe connection of claim 1, wherein the sealing surface is substantially smooth.

10. A box adapted for use in a pipe connection, said box comprising:
an interior surface for mating with a sealing surface of a pin;
an elongated thread section forming reverse locking threads along the entire length of the thread section; and
an end section for mating with a dovetail arrangement of the pin, wherein the interior surface forms a metal-to-metal seal with the sealing surface and the thread section engages with the pin along the entire length of the thread section, preventing the exacerbation of corrosion of the threads.

11. The box of claim 10, wherein the threads comprise:
a front face oriented at a first predetermined angle; and
a rear face oriented at a second predetermined angle.

12. The box of claim 11, wherein the second predetermined angle is 45°.

13. The box of claim 11, wherein the first predetermined angle and the second predetermined angle are different.

14. The box of claim 10, wherein the interior surface is substantially smooth.

15. An improved pin and box connection for tubular members of the type having a multi-groove helical thread with each groove having an entrant portion equidistant with adjacent groove entrant portions and with each groove including a negative draft load flank, wherein the improvement comprises the helical threads extending the entire length and including an end helical thread which abuttingly engages a box portion for creating a metal-to-metal seal along the entire length of the multi-groove helical thread and the end helical thread, preventing the exacerbation of corrosion of the helical thread and the end helical thread.
